(19) United States
(12) Patent Application Publication
(10) Pub. No.: US 2011/0180078 A1
(43) Pub. Date: Jul. 28, 2011

(54) Face Mask With Adjustable And Detachable Straps

(76) Inventor: Jared McKinley, Atlanta, GA (US)

(21) Appl. No.: 13/014,525

(22) Filed: Jan. 26, 2011

Related U.S. Application Data
(60) Provisional application No. 61/298,505, filed on Jan. 26, 2010.

(51) Int. Cl. A62B 9/04

(52) U.S. Cl. 128/863

(57) ABSTRACT

A protective face mask is provided that includes (1) a body portion having an inner surface and an outer surface, the body portion proportioned to fit over a nose, a mouth, and a chin of a wearer, (2) shaped forms attached to lateral portions of the inner surface, each shaped form providing a contour fit to a corresponding cheek of the wearer, (3) two flaps, each joined to a lateral portion of the body portion, and (4) at least one adjustable strap removably attachable from either end to each flap distal to the body portion, whereby each strap is extendable around the wearer's head to secure the body portion in place. The outer surface is covered by an air permeable and printable material.

### CROSS-REFERENCE TO RELATED APPLICATIONS

This application claims the benefit of U.S. Provisional Application No. 61/298,505, filed Jan. 26, 2010.

### BACKGROUND

1. Field of Invention

This invention pertains to surgical and medical face masks. More particularly, this invention pertains to protective face masks in combination with adjustable and detachable straps.

2. Description of the Related Art

Face masks and N95 respirators are devices that can be used to help prevent the spread of germs (virus and bacteria) from one person to another person. A face mask is a loose-fitting, often disposable, device used to create a physical barrier between the mouth and nose of a person and any potential contaminants in the immediate environment. The reverse is also true in that the face mask can protect other persons from being contaminated by the wearer.

Various type face masks are currently available for surgical, medical and personal use. Typical face masks are usually secured with straps that are tied behind a person's head or otherwise fit around the head or ears and hold the face mask over the person's mouth and nose. Air that is breathed in or out by the user passes through the mask.

The face mask and the securing straps are typically discarded after use. Thus, face masks and related fastening devices are seldom reused.

### BRIEF SUMMARY

According to one embodiment of the present invention, a protective face mask including (1) a body portion having an inner surface and an outer surface, and proportioned to fit over a nose, a mouth, and a chin of a wearer, (2) shaped forms attached to lateral portions of the inner surface, each providing a contour fit to a corresponding cheek of the wearer, (3) two flaps, each joined to a lateral portion of the body portion, and (4) at least one strap removably attachable from either end to each flap distal to the body portion, whereby each strap is extendable around the wearer's head to secure the body portion in place, is provided.

In some embodiments, the body portion is molded into a generally cup-shape.

In some embodiments, a nose bridge is attached proximate an edge of the inner surface of the body portion between the lateral portions of the inner surface. In some embodiments, the nose bridge is made from one of: foam, plastic, rubber. In some embodiments, the nose bridge is covered by N95 material.

In some embodiments, the protective face mask includes corresponding fasteners for attachment of either end of each strap to each flap. In some embodiments, each strap is adjustable to secure the body portion fit according to preference of the wearer.

In some embodiments, the outer surface is covered by an air permeable material. In some embodiments, the outer surface is a printable material.

Another embodiment provides a protective face mask including (1) a body portion having an inner surface and an outer surface, and molded into a generally cup shape to fit over a nose, a mouth, and a chin of a wearer, (2) first and second shaped forms attached to lateral portions of the inner surface, each providing a contour fit to a corresponding cheek of the wearer, (3) a first flap and a second flap, each joined to a lateral portion of the body portion and extending therefrom, and (4) a strap removably attachable at a first end to the first flap distal to the body portion, and removably attachable at a second end to the second flap distal to the body portion, whereby the strap is extendable around the wearer's head to secure the body portion in place.

Another embodiment provides a protective face mask including (1) a body portion having an inner surface and an outer surface, and shaped to fit over a nose, a mouth, and a chin of a wearer, (2) first and second shaped forms attached to lateral portions of the inner surface, each providing a contour fit to a corresponding cheek of the wearer, (3) a first flap and a second flap, each joined to a lateral portion of the body portion and extending therefrom, and (4) an adjustable strap removably attachable at a first end to the first flap and distal to the body portion thereof, and removably attachable at a second end to the second flap and distal to the body portion thereof, whereby the strap is extendable around the wearer's head to secure the body portion in place.

### BRIEF DESCRIPTION OF THE DRAWINGS

The above-mentioned features will become more clearly understood from the following detailed description read together with the drawings in which:

FIG. 1 is a frontal view of an embodiment of a protective face mask having an adjustable and detachable strap,

FIG. 2 is an inside view of the protective face mask according to FIG. 1,

FIG. 3 is a frontal view of another embodiment of a protective face mask having adjustable and detachable straps, and

FIG. 4 is a frontal view of another embodiment of a protective face mask having detachable straps.

### DETAILED DESCRIPTION

A protective face mask having one or more adjustable and/or removable straps is disclosed. The adjustable straps provide for a better fit in securing the protective face mask over the nose, mouth, and chin of the wearer. The removable straps provide for re-use of either the protective face mask, the straps, or both.

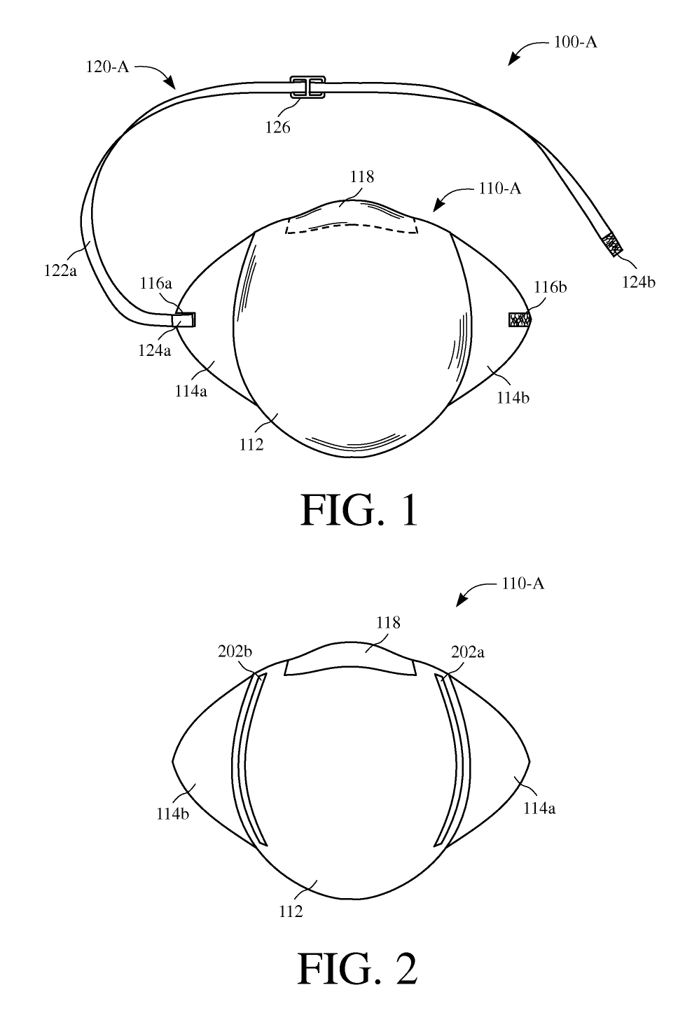

FIG. 1 is a frontal view of a protective face mask 100 having a mask 110-A and an adjustable and removable strap 120-A. The mask 110-A includes a body portion 112, first and second flaps 114a, 114b, fastener portions 116a, 116b, and a nose bridge 118. The body portion 112 has an inner surface and an outer surface. The body portion 112 typically includes multiple layers of filter material. In one embodiment, the body portion filter includes a combination of N95 respirator and an N95 medical grade surgical material. Those skilled in the art will recognize that other protective materials can be used without departing from the spirit and scope of the present invention.

The outer surface of the body portion 112 typically includes an air permeable material. In one such embodiment, the outer surface of the body portion 112 is also a printable material. Exemplary materials that are both air permeable and printable include nylon, cotton, and a combination of nylon and cotton.

A first flap 114a and a second flap 114b extend from respective lateral portions of the body portion 112. In various embodiments, the flaps 114 are nylon, polyester, or cotton cloth, for example.

In some embodiments, the outer surface material of the mask 110-A is air permeable and printed material. This outer surface material typically extends over the body portion 112 and the flaps 114 of the mask 110-A.

The nose bridge 118 is located within the inner surface of the body portion 112. However, due to the contour shape of the nose bridge 118, it is detectable within the body portion 112 when viewing the protective face mask 100-A from the front also. The internal nose bridge 118 provides for rounding the mask 110-A around the nose and mouth portion of the face. In some embodiments, the nose bridge is adjustable for providing a more secure and snug fit of the protective face mask 100-A to the face of the wearer. The internal nose bridge 118 is typically made from materials such as foam, plastic, or rubber. In one embodiment, the internal nose bridge 118 is covered with N95 material.

An adjustable and removable strap 120-A includes a strap 122a, fastener portions 124a, 124b, and an adjustment mechanism 126. In one embodiment, the strap 122a is an elasticized material and is secured to the flaps 114 by hook-an-loop fasteners. Those skilled in the art will recognize that other type fasteners such as snaps, buttons, and the like, can be used without departing from the spirit and scope of the present invention.

The fastener portion 124a at one end of the strap 122a corresponds to the fastener portion 116a of the first flap 114a. The fastener portion 124b at the opposite end of the strap 122a corresponds to the fastener portion 116b of the second flap 114b. In the illustrated embodiment, the fastener portion 124a is attached to the fastener portion 116a of first flap 114a near the end distal from the respective lateral portion of the body portion 112. The fastener portion 124b is attachable, though unattached, to the fastener portion 116b of the second flap 114b near the end distal from the respective lateral portion of the body portion 112. In the illustrated embodiment, the fastener portions 116a, 124a, and 116b, 124b are hook and loop fasteners. Those skilled in the art will recognize that other type fasteners such as snaps, buttons, studs, and the like are also suitable for securing the strap 122a to the flaps 114 of the body portion, and can be used without departing from the spirit and scope of the present invention.

During use, the strap 122a extends from the first flap 114a, around the head of the wearer, and is secured to the second flap 114b of the body portion 112 of the protective face mask 100-A. The adjustment mechanism 126 provides for securing a snug fit of the strap 122a around the wearer's head. The adjustment mechanism 126 is used by the wearer to tighten or loosen the strap 122a for a secure and comfortable fit. The illustrated embodiment includes a single adjustable and removable strap 120-A to secure the protective face mask 100-A. Those skilled in the art will recognize that multiple straps 120 can be used without departing from the spirit and scope of the present invention. Typically, a protective face mask 100 according to the present invention includes one or two straps 120. A protective face mask 100 with one strap 120 typically requires a wider strap 120 than a protective face mask 100 having two straps 120. Those skilled in the art will recognize that one or more removable fixed-length straps having custom length for the particular wearer can be used without departing from the spirit and scope of the present invention.

When secured to the face of the wearer, the protective face mask 110-A covers the nose, mouth, and chin, and protects against exposure to flu, including swine flu, and other contaminants. The protective face mask 110-A does not eliminate disease or provide cure to the wearer, but rather is a source for prevention of the spread of germs to or from the wearer.

The use of printable material for the outer surface of the body portion 112 provides for easy re-use of the protective face mask 100. Exemplary uses include art work, company or other logos, custom designs, or even various solid or multi-colored patterns. Additionally, removable or detachable straps 120 provide for greater wearer selection of varying styles and designs. For example, in addition to traditional straps 120, the wearer may desire straps 120 of different colors and/or design styles.

An additional benefit of printed material for the outer surface of the body portion 112 includes the capability to make the protective face mask 100 fashionable. The use of imprinted designs and interchangeable straps provide the protective face mask 100 with increased re-usability. In this way, the likelihood of wearing the protective face masks 100 in public locales is increased for those circumstances where such use has previously been less than ideal. For example, the protective face mask 100 is more likely to be worn in circumstances where a face mask is not normally required, but where a person is nonetheless concerned for their own well-being, or alternatively concerned for the well-being of others.

FIG. 2 is an inside view of the protective face mask 100-A. The inside cavity of the body portion 112 is typically a combination of N95 respirator mask and N95 medical grade surgical mask material. The combination is layered within the cavity of the body portion 112.

The inside cavity of the body portion 112 includes shaped form material 202a, 202b at the lateral portion of the body portion 112. This shaped form material 202a, 202b provides contour to the cheek area of the protective face mask 100-A. Additionally, the shaped form material 202a, 202b, provides a protective barrier at the lateral edges of the body portion 112. Also, the shaped form material 202a, 202b, provides a secure and snug fit of the protective face mask 100-A to the cheeks of the wearer.

As noted above, the nose bridge 118 is located within the inner surface of the body portion 112 of protective face mask 100-A. The internal nose bridge 118 provides for rounding the mask 110-A around the nose and mouth portion of the face. In some embodiments, the nose bridge is adjustable for providing a more secure and snug fit of the protective face mask 100-A the face of the wearer. The internal nose bridge 118 is typically of materials such as foam, plastic, or rubber. In one embodiment, the internal nose bridge 118 is covered with N95 material.

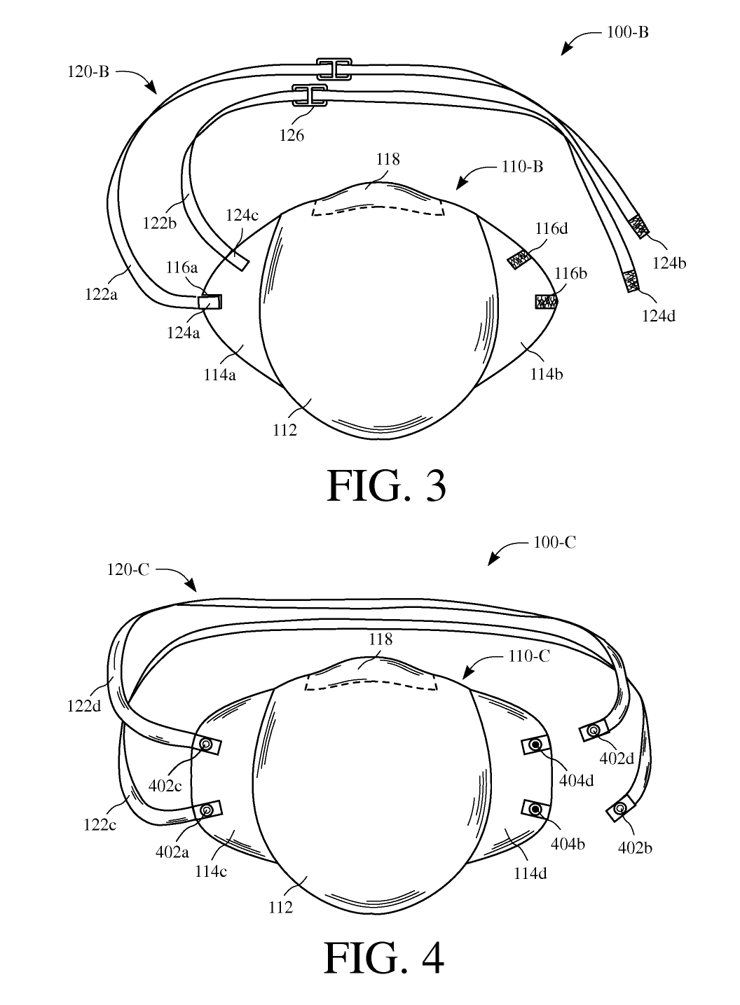

FIG. 3 is a frontal view of a protective face mask 100-B having a mask 110-B and two adjustable and removable straps 120-B. Excepting for the additional strap 122b, the protective face mask 100-B is substantially as described above. An additional strap 122b includes a fastener portion 124c, 124d at either end, and an adjustment mechanism 126 as above. The first flap 114a includes an additional fastener portion 116c (not shown) to which fastener portion 124c of the strap 122b is connected. The second flap 114b includes an additional fastener portion 116d. The fastener portion 124d of the strap 122b is attachable to fastener portion 116d of the second flap. Of course, the fasteners at either end of the straps 122 are interchangeable and are connectable to either of the flaps 114.

FIG. 4 is a frontal view of a protective face mask 100-C having a mask 110-C and removable straps 120-C with alternative fasteners. In the illustrated embodiment, the first and second flaps 114c, 114d are slightly elongated laterally along the body portion 112 of the mask 110-C. This provides for fastener portions 116 that are substantially symmetrical in positioning on the flaps 114. In one embodiment, the straps 122c, 122d are non-adjustable. In such an embodiment, the straps 122c, 122d are custom fitted for the particular wearer. This eliminates the need for adjustment of the straps with each use of the protective face mask 100-C.

In the illustrated embodiment, the fastening mechanism of the strap 122 is a snap 402 affixed to a post 404 on each flap 114. Specifically, the snap 402a at one end of the strap 122c is fastened to the post 404a (not shown) on flap 114c. The snap 402b at the opposite end of the strap 122c corresponds to the post 404b on flap 114d. Similarly, the snap 402c at one end of the strap 122d is fastened to the post 404c (not shown) on flap 114c. The snap 402d at the opposite end of the strap 122d corresponds to the post 404d on flap 114d.

It should be appreciated that many type fasteners are useable with the protective face-mask 100 of the present invention. For example, this disclosure has described hook-an-loop fasteners and snap-and-post fasteners as non-limiting examples. Those skilled in the art will recognize that other fasteners such as hook-and-eye loops, buttons, various types of snaps (capped snaps, ring snaps), and the like can be used without departing from the spirit and scope of the present invention.

From the foregoing description, it will be recognized by those skilled in the art that a protective face mask that includes adjustable and/or removable straps providing for re-use of either the protective mask or the straps, has been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A protective face mask, said protective face mask comprising:
a body portion having an inner surface and an outer surface, the body portion proportioned to fit over a nose, a mouth, and a chin of a wearer;
shaped forms attached to lateral portions of the inner surface, each shaped form providing a contour fit to a corresponding cheek of the wearer;
two flaps, each flap joined to a lateral portion of the body portion; and
at least one strap removably attachable at either end to each flap distal to the body portion,
whereby each at least one strap is extendable around the wearer's head to secure the body portion in place.

2. The protective face mask of claim 1 wherein the body portion is molded into a generally cup-shape.

3. The protective face mask of claim 2 further including a nose bridge attached proximate an edge of the inner surface of the body portion between the lateral portions of the inner surface.

4. The protective face mask of claim 3 wherein the nose bridge is made from one of the following: foam, plastic, rubber.

5. The protective face mask of claim 3 wherein the nose bridge is covered by N95 material.

6. The protective face mask of claim 1 further including corresponding fasteners for attachment of either end of the at least one strap to each flap.

7. The protective face mask of claim 1 wherein each at least one strap is adjustable to secure the body portion fit according to preference of the wearer.

8. The protective face mask of claim 1 wherein the outer surface is covered by an air permeable material.

9. The protective face mask of claim 8 wherein the outer surface is a printable material.

10. A protective face mask, the protective face mask comprising:
a body portion having an inner surface and an outer surface, the body portion molded into a generally cup shape to fit over a nose, a mouth, and a chin of a wearer;
first and second shaped forms attached to lateral portions of the inner surface, each shaped form providing a contour fit to a corresponding cheek of the wearer;
a first flap and a second flap, each flap joined to a lateral portion of the body portion and extending therefrom; and
a strap removably attachable at a first end to the first flap distal to the body portion, and removably attachable at a second end to the second flap distal to the body portion,
whereby the strap is extendable around the wearer's head to secure the body portion in place.

11. The protective face mask of claim 10 further including a nose bridge attached proximate an edge of the inner surface of the body portion between the lateral portions of the inner surface.

12. The protective face mask of claim 11 wherein the nose bridge is made from one of the following: foam, plastic, rubber.

13. The protective face mask of claim 11 wherein the nose bridge is covered by N95 material.

14. The protective face mask of claim 10 further including corresponding fasteners for attachment of either end of the at least one strap to each flap.

15. The protective face mask of claim 10 wherein each at least one strap is adjustable to secure the body portion fit according to preference of the wearer.

16. The protective face mask of claim 10 wherein the outer surface is covered by an air permeable material.

17. The protective face mask of claim 16 wherein the outer surface is a printable material.

18. A protective face mask, the protective face mask comprising:
a body portion having an inner surface and an outer surface, the body portion shaped to fit over a nose, a mouth, and a chin of a wearer;
first and second shaped forms attached to lateral portions of the inner surface, each shaped form providing a contour fit to a corresponding cheek of the wearer;
a first flap and a second flap, each flap joined to a lateral portion of the body portion and extending therefrom; and
an adjustable strap removably attachable at a first end to the first flap and distal to the body portion thereof, and removably attachable at a second end to the second flap and distal to the body portion thereof,
whereby the strap is extendable around the wearer's head to secure the body portion in place.

19. The protective face mask of claim 18 wherein the outer surface is covered by an air permeable material.

20. The protective face mask of claim 19 wherein the outer surface is a printable material.
